(19) United States
(12) Patent Application Publication
(10) Pub. No.: US 2022/0377842 A1
(43) Pub. Date: Nov. 24, 2022

(54) SYSTEM AND METHOD FOR AN INTERNET OF THINGS

(71) Applicant: Focus Universal Inc., Ontario, CA (US)

(72) Inventor: Desheng Wang, Diamond Bar, CA (US)

(21) Appl. No.: 17/748,917

(22) Filed: May 19, 2022

Related U.S. Application Data
(60) Provisional application No. 63/190,616, filed on May 19, 2021.

(51) Int. Cl. H04W 84/18; H04L 67/12

(52) U.S. Cl. CPC H04W 84/18; H04L 67/12

(57) ABSTRACT

Disclosed is an Internet of Things system for allowing hub to device and device to device communication on the system. The system is built on a backbone of physical power lines and primarily relies on a power line communication protocol for sending messages between the hub and the devices or between devices. Each of the devices on the system, regardless of function is built on foundational architecture which guarantees that the device will be able to communicate on the system. A smart device, operating in conjunction with a universal device acts as the hub of the system.

### CROSS-REFERENCE TO RELATED APPLICATIONS

The present application claims the benefit of priority to U.S. Provisional Patent Application No. 63/190,616, filed May 19, 2021, the disclosure of which is hereby incorporated by reference in its entirety. Any and all applications for which a foreign or domestic priority claim is identified in the Application Data Sheet as filed with the present application are hereby incorporated by reference under 37 CFR 1.57.

### FIELD

The present invention relates to a system and method of providing an internet of things.

### BACKGROUND

The Internet of Things (IoT) is a system of interrelated devices that are connected to a network, exchanging data without necessarily requiring human-to-machine interaction. Examples include smart factories, smart home devices and systems, medical monitoring devices and systems, wearable technology devices, for example, fitness trackers, and smart city infrastructures. IoT devices are often interchangeably called “smart” devices. This is because IoT devices typically have sensors and complex data analysis programs. IoT devices collect data using sensors and offer services to the user based on the analyses of the data and according to user-defined parameters.

IoT was first proposed in 1985. As mentioned above, IoT may include many different types of devices totaling billions of physical devices around the world that are connected to the internet, collecting and sharing data. The emerging technology of the IoT offers the greatest opportunities to create new business and generate the associated revenues, and thus ranks as the number one disruptive technology. With IoT, some near term estimates conclude 75 billion physical devices need to be connected to the internet within five years. However, the current design model for IoT devices includes designing each device from scratch. Between the amount of hardware and software design and follow on production work currently required, the design-from-scratch model is not feasible to meet near term demand. The strongest indication of this fact is that even though more than 30 years have passed since it's proposal, IoT technology is still in the concept stage.

The current state of the art IoT technology is based on brand-centric eco systems consisting of design from scratch devices. That is, groups of devices from a single company which share a proprietary operating environment. For example, one company may produce a smart speaker which may include some version of virtual assistant technology. The same company may also produce a camera which allows a user to monitor the interior or exterior, or both, of the user's residence remotely over the internet. The same company may further produce a doorbell system which includes a camera which a user may use to see who is at their door, even from a remote location, when the doorbell is rung. Because the devices are all from a single source, they share a proprietary operating environment or system and are thus guaranteed to interoperate. However, they are also marketed as standalone products. Thus, due to being designed from scratch, many of such smart home products take an extraordinary amount of time to bring to market which elevate the cost of each item of the smart home system.

However, if a consumer favors the features of a smart speaker from one company and a doorbell system from a different company, there is no guarantee the two will interoperate, in fact, the truth is quite the opposite, because of design from scratch and the proprietary operating systems, the two devices are nearly guaranteed to not interoperate.

Making matters worse, not only are the ecosystems proprietary because of the operating system, but the ecosystems are often created haphazardly. A typical scenario includes a company creating a first device. The operating system is often created with only the device itself in mind. Such a first product must be a success in order for the company to raise enough capital to research and develop follow on products. Thus, the first product is optimized for its particular purpose without regard for interoperability with other devices in an ecosystem. If the first product is a success, the company must develop interoperability with the first device, which is almost exclusively optimized for anything but interoperability. Thus, the company must use less than ideal means to establish interoperability in creating an ecosystem of devices. Using such a haphazard system, it is nearly impossible to create an IoT of billions of devices where such devices speak directly to each other using point to point communication, rather than first device to hub to second device communication.

Sometimes the haphazard choices in creating devices for an ecosystem are dominated by economics. Price of any device is always a constraining factor in design of the device. Ultimately, the price may constrain features, including networking features which determine how well a particular device or group of devices will function in an ecosystem. While it may be technically possible to include a myriad of possible wired and wireless connections for the devices in an ecosystem, the cost to do so would lead to pricing that is not competitive in the consumer marketplace. Typically, this leads to the company choosing a single, often wireless, connection method for the ecosystem. The choice of a wireless connection eliminates concerns regarding what wired infrastructure the consumer may have. However, the wireless connection may be suboptimal for any number of reasons, but the consumer is left with no choice. Moreover, the choice of wireless communication almost demands a costly and time-consuming design from scratch model for devices and systems.

For the foregoing reasons, there is a need for an IoT system which has a competitive cost, but offers universal connectivity and devices which are able to not only perform desired functions, but also able to communicate with each other.

### SUMMARY

Disclosed is an internet of things system to provide for communication between devices. The internet of things system may include an electrical power line. One or more IoT devices may be electrically connected to the power line. The one or more IoT devices may each include a first set of circuitry for performing a first set of one or more functions, a first transceiver, a first memory, and a first processor. A PLC protocol may be stored on the first memory and may execute on the first processor to send messages over the electrical power line. The messages may include initialization information, or control signals or sensor data, or a combination of initialization information, control signals, and sensor data. The internet of things system may further include a universal device which may be electrically connected to the electrical power line and wirelessly connected to at least one computing device. The universal device may exchange messages with the one or more IoT devices and the at least one computing device. The universal device may include a power line transceiver and a wireless transceiver. The one or more IoT devices, at least one computing device and universal device may all use a common foundational hardware design and the communication protocol to communicate directly from one of the one or more IoT devices to another of the one or more IoT devices, or from one of the one or more IoT devices through the universal device to one of the at least one computing device.

Further disclosed is a method for providing control of an IoT system. The method may include providing a computing device including a display. The method may further include connecting a universal device to the computing device via a wired or wireless connection. The method may further include connecting one or more IoT devices to the universal device via a wired connection. The one or more IoT devices and the universal device may each include a transceiver to send and receive messages. The messages may be formatted using a PLC protocol. The method may further include sending a message from the computing device to the one or more IoT devices. The message may request initialization information. The method may further include sending a message from the one or more IoT devices to the computing device. The message may include initialization information. The initialization information may include information regarding one or more unique functions of the corresponding one of the one or more IoT devices and control parameters of the one or more unique functions. The method may further include creating a user interface for displaying on the display of the computing device. The user interface may include control surfaces which, when manipulated by a user, may cause a change in a value of one of the control parameters of one of the one or more functions of one of the one or more IoT devices. The method may further include manipulating a control surface to operate one of the one or more IoT devices.

Further disclosed is an IoT system for allowing the interoperation of devices. The system may include a computing device. The computing device may send control signals using a PLC protocol. They system may further include a universal device. The universal device may include a first transceiver for sending data to, and receiving data from, the computing device, and a non-transitory first memory. The first memory may be electrically connected to the transceiver. The first memory may contain the PLC protocol. The system may further include one or more IoT devices. The one or more IoT devices may be connected to the universal device through electrical power lines. The one or more IoT devices each may include one or more unique functions. The one or more IoT devices may each include a second memory storing a first copy of the PLC protocol, and a second transceiver may be electrically connected to the second memory and may communicate with the universal device using the PLC protocol. The system may further include one or more sensors connected to the one or more IoT devices through the electrical power lines. The one or more sensors may each include a third memory. The third memory may store a second copy of the PLC protocol. A third transceiver may be electrically connected to the third memory and may communicate with the universal device using the PLC protocol. One of the one or more sensors may send a control signal directly to one or more of the one or more IoT devices.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic diagram of the IoT system;

FIG. 2 shows a plan view of a user interface;

FIG. 3 shows a flowchart of operation of the IoT system;

FIG. 4 shows a diagram the two sinusoidal waves emitted by the two crystal oscillator circuits;

FIG. 5 shows a diagram of a control signal; and

FIG. 6 shows a schematic view of an IoT device.

### DETAILED DESCRIPTION

The detailed description set forth below in connection with the appended drawings is intended as a description of the presently preferred embodiment of system and method to make and use an IoT system, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

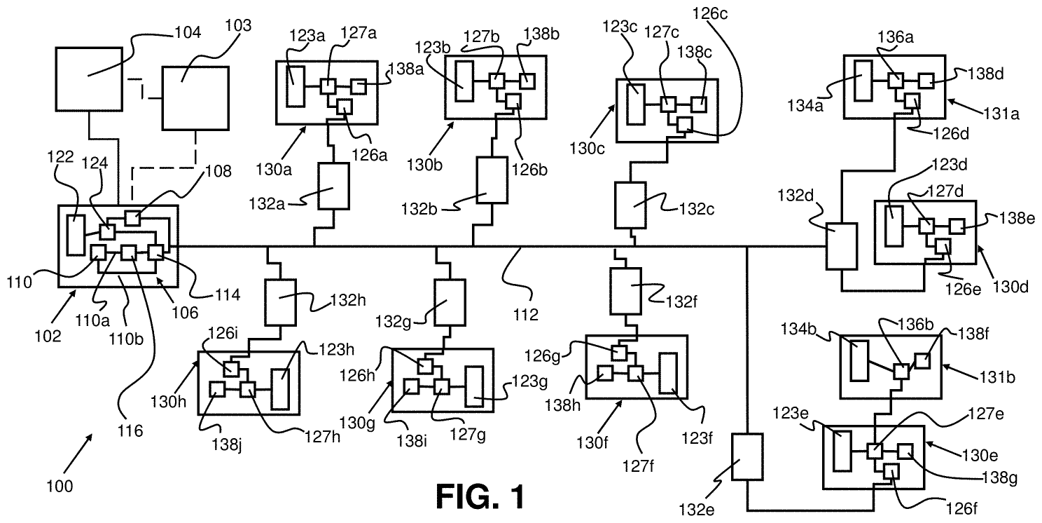

Disclosed is an Internet of Things (IoT) system and method. With reference to FIG. 1, the IoT system 100 may have a plurality of key technologies which enable the function of the system and method. The first technology may be the electrical wiring infrastructure which was built along with a structure, building complex, neighborhood, or city to provide power to the structure, building complex, neighborhood, or city. The electrical wiring infrastructure provides a ready-made network for the system. The next technology applied to create the IoT system 100 includes a foundational architecture incorporated in either IoT devices or sensors connected to the power line network. The foundational architecture allows the IoT devices and sensors to send messages to each other, and to a universal device on the system. One key component of the foundational architecture may be a transceiver of a specific design which encodes binary information in a specific way. The transceivers create communication signals which are placed on the power line wiring infrastructure. This power line communication (PLC) signal is placed on the electrical wiring in addition to the power signal already present. The transceivers may each be connected to a processor and a memory. The memory may store a protocol which executes on the processor to send a PLC control signal or other data on the power lines. The PLC control signal may allow the IoT devices and sensors including the transceivers to communicate with each other directly. The IoT devices and sensors may also communicate with a transceiver enabled universal device connected to the power line network. The universal device may allow a smart device to access the IoT system either through a wired or wireless connection. The smart device may act as a central control device to give the IoT system a hybrid open loop/closed loop architecture as is described in further detail below.

The devices may include IoT devices which perform a variety of functions and sensors either operating independently or in conjunction with an IoT device. Each of the IoT devices and sensors may have a foundational architecture which allows the device to communicate on the IoT system. From this foundational architecture, that is, a combination of computer hardware and software, additional computer architecture may be added to the IoT device or sensor to provide the IoT device with any function or set of functions desired by the designer. However, generally speaking, the sensors generally include additional architecture which allow the sensor to collect data which may be used to change the functioning of an IoT device. The IoT devices themselves can perform a single function or set of functions. These functions may be computer functions, mechanical functions, or other functions, or a combination of functions. The foundational architecture is also secure, because during customization, a designer may add any architecture on top of the foundational architecture. When a designer does this, the designer may choose the protocol that the added computer architecture uses to interface with the foundational architecture.

The final technology in the plurality of technologies is that embodied by the universal device. The same foundational architecture of the IoT devices and sensors or may be included in the universal device. The universal device may perform various device management functions and may allow access, both wired and wireless, to devices which do not natively use the PLC protocol to communicate on the network directly. The device management functions may allow a computing device connected to the universal device, either through a wired or wireless connection, to send control signals for controlling various functions of one or more of the IoT devices, or for setting parameters used by the sensors for closed loop functions. Thus, the universal device performs critical functions in enabling the open loop operation of the IoT system.

More specifically, with reference again to FIG. 1, the IoT system 100 may include a computing device 104. The computing device 104 may be a mobile computing device. For example, a mobile computing device such as a smartphone or tablet running an Android®, iOS®, or Windows® operating system. The software application running on the computing device 104 may be an application, often abbreviated as an “app,” programmed to operate on, for example, Android®, iOS®, or Windows® operating systems, or a combination of more than one of the operating systems. The computing device 104 may also be a laptop or a desktop computer. The laptop or desktop computer may include a software package available for personal computers running operating systems such as Microsoft® Windows®, Mac® OS, Unix, Linux, etc., or a combination of more than one of the operating systems. Alternatively, the computing device may be any device which provides a display to display control surfaces, and allows the control surfaces be manipulated to send commands to one or more IoT devices and parameters to one or more sensors on the IoT system. The computing device 104 may also receive data from designated IoT devices or sensors, or both, on the IoT system, and provide a display populated, at least in part, by the received data. In systems were essentially real time data is being taken by the sensors, the volume of data may be enough to overwhelm the computing device, causing the computing device to cease operating. Thus, only a portion of the data collected by the sensors may be sent to the computing device. The computing device may further summarize the sent data for display. The computing device may be connected to a universal device through a wired or wireless connection.

The computing device 104 may be electrically connected to the universal device 102. The universal device 102 may include programming which allows the universal device 102 to interoperate with computing devices 104 using various operating systems. Because of this feature, not only may more than one computing device 104 be used with the system, but each computing device 104 may have a different operating system. The system may operate with only a single computing device 104 accessing the system through the universal device 102 at a time, or the system may allow more than one computing device 104 to access the universal device 102 at a time. This interoperation is part of what makes the universal device 102 operate in a universal manner. The universal device 102 may receive messages from, and send messages to, any computing device 104 which a user wishes to place in to operation with the IoT system 100, making the universal device 102 agnostic in regard to the interoperability with computing devices 104 using any of a number of operating systems.

The universal device 102 may connect to the computing device 104 through a wired or wireless connection and, additionally, the universal device 102 may connect to a power line 112 which provides the communication backbone for the IoT system as a whole, and specifically, the IoT devices 130a-h and sensors 131a, 131b. The universal device 102 incorporates several modules of computer architecture, that is, assemblies of combined hardware and software, which enable the universal device 102 to perform its functions on the IoT system 100. One of these modules of computer architecture is the foundational architecture. The foundational architecture may include a transceiver. The transceiver may be connected to a processor. The processer may be connected to a memory which stores an open source PLC protocol. While existing electric wiring may provide the network infrastructure for the IoT system, the PLC protocol actually forms and sends the messages used to communicate to the IoT devices and sensors.

Alternatively, or in addition, the IoT system 100 may include a display panel 103 hardwired to, or integrated with, the universal device 102. The display panel 103 may include touch screen technology and software which allows a user to control IoT devices 130a-h and set parameters for sensors 131a, 131b on the IoT system 100. For example, the display panel 103 may include programmable logic controller technology. The programmable logic controller may be integrated with the universal device 102. Thus, the display panel 103 may allow a user to use the computing device 104 as an extension of the display panel 103, or to operate devices and sensors on the IoT system 100 from the display panel 103. Thus, the display panel 103 and the computing device 104 can be used in parallel, for example, to operate two different IoT devices or send parameters to sensors, or monitor data being taken by sensor contemporaneously. Alternatively, the display panel 103 may be a tablet computer. The table computer may also be integrated with the universal device 102. The display panel 103 may include a wireless module which allows the display panel 103 to communicate with the computing device 104, and allows for pass through of computing device 104 messages to the universal device 102. For ease of explanation, when used in the remainder of this disclosure, the term “universal device,” is understood to include the display panel 103 unless specifically stated otherwise.

The universal device 102 and display screen 103 combination may include a screen which allows a user to view data passed from one or more IoT devices 130a-h or sensors 131a, 131b and to generate commands to be sent to one or more of the IoT devices 130a-h or sensors 131a, 131b for action. The universal device 102 may include a number of circuits and components which would be common to design from scratch IoT devices. These features are typically redundantly included in design from scratch IoT devices. By way of example and not limitation, both a thermostat and a sprinkler control system may include display screens. Rather than have a display screen on both of the sprinkler control system and the thermostat, the display on the computing device 104 or on the universal device 102, or both, provide a display which performs all the display tasks for the IoT system 100. Thus, this one display on the computing device 104 or the universal device 102 replaces the screens on the traditional sprinkler system and thermostat. The universal device 102 may include other circuits or components that would be common to all design from scratch IoT devices. The inclusion of these components and circuits in the universal device 102 or computing device 104 or both, through either hardware or software, integrates tasks which would normally be performed by a traditional peripheral device in to the universal device 102 and the computing device 104.

The transceiver 126a-i, processor 127a-h 136a, 136b, memory 123a-h, 134a, 134b, and PLC protocol are all part of the foundational architecture shared by the universal device 102, the one or more IoT devices 130a-h, and the one or more sensors 131a, 131b. This foundational architecture ensures that any device or sensor added to the IoT system 100 will be able to communicate with the computing device 104 through the universal device 102, the universal device 102 itself, the IoT devices 130a-h on the IoT system 100, and the sensors 131a, 131b on the IoT system 100. The foundational architecture allows IoT device and sensor designers to design from the foundational computing architecture rather than designing from scratch. This not only saves design time by eliminating redundancy of design, but it also guarantees that any IoT device or sensor designed will be able to interoperate with other IoT devices, sensors, and universal devices, and that control signals sent from, and data sent to, a computing device accessing the IoT network through a universal device will be able to operate IoT devices and receive feedback and data from the IoT devices and sensors. Thus, with the wiring infrastructure essentially ubiquitous, and the computing architecture designed and ready for customization, IoT devices and sensors of the disclosed IoT system may be produced at much faster rates.

This foundational architecture may be added to in order to customize IoT devices 130a-h and sensors 131a, 131b. IoT devices may be customized by adding computer architecture or other hardware which enables the IoT device to perform a function or set of functions. The protocol used by the designer of the IoT device for operating the customized hardware, as part of the customized computer architecture or other hardware, may interoperate with the protocol however the designer desires. The software portion of the computer architecture may be designed so it can convert messages from and to the PLC protocol, but then may be translated into a protocol chosen or designed by the designers to make the hardware on the IoT device function according to the control signals of the PLC protocol. This allows the protocol that operates the hardware of the customized portion to be kept largely, if not completely, proprietary. Also, the requirement not to use the PLC protocol throughout the entirety of IoT devices and sensors may allow for greater design efficiency, as these IoT devices and sensors do not have to be designed around a single protocol for their operation, but may take advantage of existing computer architecture, including designer created protocol for operation of the IoT devices and sensors.

Each of the one or more IoT devices 130a-h may be electrically connected to one or more sensors 131a, 131b either directly or through the power line 112. Alternatively, one or more sensors 131b may be integrated with an IoT device. For example, the IoT devices 130a-h may include lights, fans, outdoor sprinkler valves, garage door openers, automated blinds, thermostats, doorbell camera systems, and medical devices, among others. The sensors may measure various aspects of the environment or the IoT system itself. For example, the sensors may measure power levels of batteries, temperature, current flow, wind speed, pH level, electrical conductivity in water, and light levels, among other types of measurements. The PLC protocol allows both control signals and raw sensor data to be converted by the PLC protocol to messages that may be sent on the IoT network. Each of the IoT devices 130a-h and independent sensors 131a may include a transceiver 126a-I which generates signals, and transmits the signals to the power line 112. The signals may include control signals, including commands, parameters for use in sensors, and data signals including measurement results.

A PLC transceiver 108 may be integrated with the universal device 102. The primary function of the PLC transceiver 108 is to send signals as directed by the controller 102, or the computing device 104, or both. The PLC transceiver 108 sends a signal upon which control information is encoded. The PLC transceiver may also receive data signals from the IoT devices 130a-h and sensors 131a. 131b. For example, the IoT devices 130a-h or sensors 131a, 131b may send acknowledgements of messages or self-identification information to the universal device 102.

The PLC transceiver 106 may include a single crystal oscillator 110. When power is applied to the crystal oscillator 110, the crystal oscillator 110 produces a signal at a frequency based on the structure of the crystal oscillator 110. The signal produced by the crystal oscillator 110 may be sent to an output. From the output, the signal may be split on two different signal paths. Alternatively, the PLC transceiver 106 includes two crystal oscillator circuits 110a, 110b. The crystal oscillator circuits draw power from the power line 112. The power is taken from the power line 112 and transformed down from 110V to 0.1V. On a 10 amp circuit of the power line 112, the 0.1V of transformed voltage produces one watt of power for the crystal oscillator circuit. As long as the crystal oscillator circuit 110a, 110b receives power, the crystal oscillator will continue to output a wave signal.

Crystal oscillators emit a sinusoidal wave at a frequency determined by their physical structure. The crystal oscillators, and particularly quartz crystal oscillators, have a very high Q factor. The Q factor, as is well known in the art, is the resonant frequency of the crystal divided by the bandwidth. Quartz crystal oscillators are capable of primary frequencies in the high kHz up the MHz range. Also, as indicated by the high Q factor, they have a narrow bandwidth. A typical Q factor for a quartz oscillator ranges from 10⁴ to 10⁶, compared to 10² for an inductor and capacitor, or LC, oscillator. The maximum 0 for a high stability quartz crystal oscillator can be estimated as Q=1.6×10⁷/f, where f is the resonant frequency in megahertz.

Another aspect of a quartz crystal oscillator is that a quartz crystal oscillator exhibits very low phase noise. In many oscillators, any spectral energy at the resonant frequency is amplified by the oscillator, resulting in a collection of tones at different phases. In a crystal oscillator, the crystal mostly vibrates on one axis, therefore only one phase is dominant. Low phase noise makes crystal oscillators particularly useful in applications requiring stable signals and very precise time references.

A quartz crystal provides both series and parallel resonance. The series resonance is a few kilohertz lower than the parallel resonance. Crystals below 30 MHz are generally operated between series and parallel resonance, which means that the crystal appears as an inductive reactance in operation, this inductance forming a parallel resonant circuit with externally connected parallel capacitance. Any small additional capacitance in parallel with the crystal pulls the frequency lower. Moreover, the effective inductive reactance of the crystal can be reduced by adding a capacitor in series with the crystal. This latter technique can provide a useful method of trimming the oscillatory frequency within a narrow range; in this case inserting a capacitor in series with the crystal raises the frequency of oscillation. For a crystal to operate at its specified frequency, the electronic circuit has to be exactly that specified by the crystal manufacturer. Note that these points imply a subtlety concerning crystal oscillators in this frequency range: the crystal does not usually oscillate at precisely either of its resonant frequencies.

Crystals above 3 MHz (up to >200 MHz) are generally operated at series resonance where the impedance appears at its minimum and equal to the series resistance. For these crystals the series resistance is specified (<100Ω) instead of the parallel capacitance. To reach higher frequencies, a crystal can be made to vibrate at one of its overtone modes, which occur near multiples of the fundamental resonant frequency. Only odd numbered overtones are used. Such a crystal is referred to as a 3rd, 5th, or even 7th overtone crystal. To accomplish this, the oscillator circuit usually includes additional LC circuits to select the desired overtone.

The transceiver 106, may include a single crystal oscillator which is output to two different signal paths 110a, 110b. Each of the signal paths may further modify the signal on that path, as described in detail below. Alternatively, the transceiver 108 may include two crystal oscillator circuits, one on each signal path. The crystal oscillator circuits may be essentially identical, and may include some amplification. Each crystal oscillator circuit includes an output. The signal generated by each of the crystal oscillator circuits is sent to the output.

A signal on one signal path 110a is next routed to a phase shift sub-circuit 116 to phase shift that signal. The phase shifted signal is then routed to one terminal of a switch 114. The signal on the other signal path 110b is routed to the other terminal of the switch 114. The switch 114 may be a fast switching operation, as is well known in the art, or any other switch which is able to provide fast enough switching, including transistors which may act as switches by having a voltage applied to, and then disconnected from, the base of the transistor. The switch 114 may have the form of a single pole, dual throw, or SPDT switch. An output may be connected to the common of the switch 114. The speed of the switch 114 allows for very rapid alternation between the first signal and the phase shifted second signal. By way of example and not limitation, the switch 114 may cycle fast enough to switch 10 times from the first signal to the second signal and back to the first signal in a single cycle of a 40 MHz signal. Thus, there is an opportunity, depending on the PLC protocol used by the system, to send 10 bits of information in a single 40 MHz cycle, all without interference by noise. In this example, the IoT system 100 could generate 400 million bits of information a second on a bandwidth of a single frequency. Alternatively, the switch 114 may cycle fewer than 10 times in a 40 MHz cycle, or more than 10 times in a 40 MHz cycle. Still further alternatively, the crystal oscillator may generate a sinusoidal wave at more than 40 MHz or less than 40 MHz. The operation of the system, including the creation and switching between the sinusoidal waves produced by the crystal oscillators is discussed in detail below. The transmission portion 106 is electrically connected to a transceiver output, which is in turn connected to the power line 112.

The universal device may include a memory 122 on which the PLC protocol is stored, and a processor 124 which is electrically connected to the memory 122, and on which the PLC protocol is executed. The PLC protocol may include a portion which interprets commands sent by the display screen 103 or computing device 104, or from an IoT device or a sensor transceiver. The PLC protocol, executed by the processor 124, accomplishes the encoding of the sinusoidal waves generated by the crystal oscillator circuits 110a, 110b, one of which is then phase shifted, by controlling the switch. Additional details related to PLC are discussed in International Patent Application Publication No. WO 2021/107961, which is hereby incorporated by reference herein.

The IoT devices 130a-h and sensors 131a, 131b may be connected to the wiring infrastructure by a cord with a plug configured to fit a standardized socket in an outlet 132a-h connected to the power line 112. The universal device 102 may be hardwired to the electrical power line 112, or may also include a cord which plugs in to a socket in an outlet. The socket may be placed in a junction box where it can be accessed either inside or outside of a structure.

Moreover, the IoT devices 130a-h and sensors 131a, 131b for traditional non-IoT devices, for example, lamps, can, in addition to making the lamp part of the IoT system 100, add smart features to the lamp. For example, a dimming feature, controllable by the computing device 104 and the universal device 102, may be added to the IoT devices 130a-h and sensors 131a, 131b for the lamp. The IoT devices 130a-h and sensors 131a, 131b could use a variable resistor, the level of which may be set by a control surface on a user interface created by a software application, to vary the wattage to the lamp. Thus, lamps which were previously either on or off only may now be dimmed. Thus, not only may features be off loaded to the computing device 104 and the universal device 102 to remove common circuits and components from the module, but, as is show with the lamps, new features may be added that would have been prohibitively expensive to add to a lamp without the disclosed IoT system 100.

IoT devices for the disclosed IoT system may also be designed without any regard to requirements for an IoT device to operate as a stand-alone device. With this design style, only the most unique functions are added to the foundational architecture to create the newly designed IoT device, while the redundant and common circuits and components are off loaded to the computing device 104 and universal device 102. The cost to produce IoT devices 130a-h using this design paradigm drives the cost much lower than the traditional devices they replace. Because some of the functions previously performed on the traditional IoT device are off loaded, in the disclosed IoT system 100, to the computing device 104 and universal device 102, the components for those functions are no longer needed by the IoT devices 130a-h and sensors 131a, 131b. Centralizing functions and their corresponding components lowers the cost to produce an IoT device 130a-h or sensor 131a, 131b while also making the IoT system 100 more user friendly. The IoT system 100 may be more user friendly because a user no longer has to physically go to each IoT device or sensor in order to operate the device or obtain data from it, for example, going to a sprinkler system controller to operate the sprinkler system, or to the installation site of a thermostat to operate the thermostat. Rather, the user can operate all of the IoT devices 130a-h and change parameters on sensors 131a, 131b on the IoT system 100 from a single location. That location may be a mobile due to a wireless connection. For example, a computing device 104 with a wireless connection to the universal device 102. Alternatively, the location may be a fixed location with a desktop computing device 104, or a display panel 103. Still further alternatively, all of the above computing devices may be used in any combination, and therefore be mobile or fixed as the user desires.

As can be easily understood from the discussion of the components of the IoT system 100, the disclosed IoT system 100 is customizable to almost every implementation. The ability to customize allows the system to be used in both industrial and residential applications. The IoT system 100 may be based around the universal device 102. A computing device 104 may make control easier, for example, by placing the ability to control in a user's pocket, but is not required for operation of the IoT system 100. Further, there may be more than one model of the universal device 102. By way of example and not limitation, the universal device may have a first model which relies on the computing device for the display, and all commands must be sent using the computing device. Alternatively, another model of the universal device may be integrated with a display screen as discussed above. This model may allow parallel use of the display screen and computing device in sending commands, or for a user to choose between exclusive use of the display screen or computing device from time to time.

The universal device 102, IoT devices 130a-h and sensors 131a, 131b may be purchased based on what a user needs the IoT system to accomplish. If a user knows that a universal device will almost always be connected to a computing device, that user may not need a universal device with a display screen. A user living in a home in a geographic region with heavy year-round rainfall may choose to not purchase sprinkler system related IoT devices and sensors because the user's home does not have sprinklers. However, the same user may purchase one or more light fixture IoT devices to intelligently control the lighting of the home.

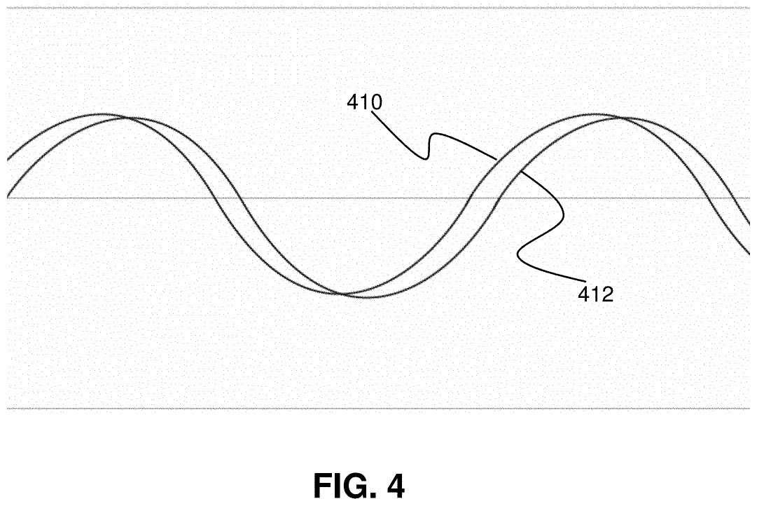

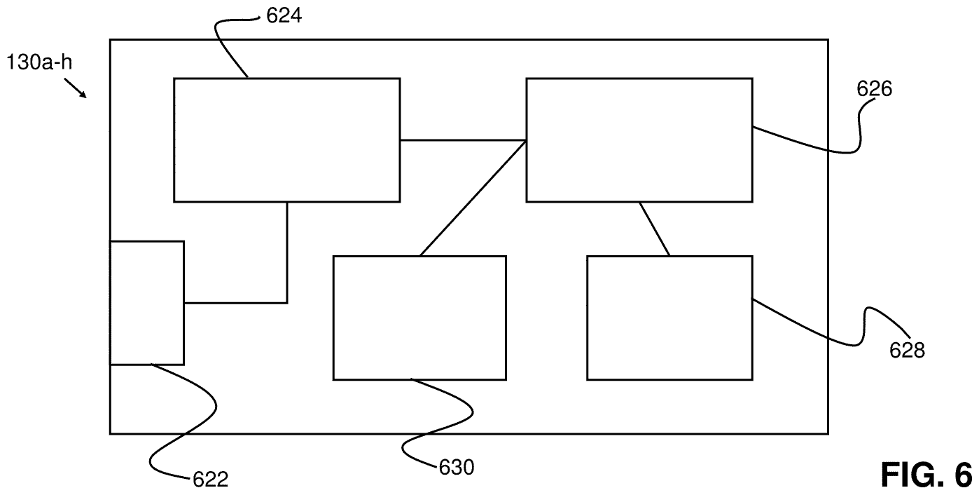

In operation, with reference to FIGS. 1-6, when a computing device 104 is connected to IoT network though the universal device 102, the computing device 104 may send a message to the universal device 102 requesting initialization information regarding connected IoT devices 130a-h and sensors 131a, 131b. Additionally, when a new IoT device 130a-h or sensor 131a, 131b is connected to the IoT network, the IoT device 130a-h or sensor 131a, 131b may automatically send initialization information to the universal device 102. Alternatively, as part of the universal device's device management functions, the universal device 102 may detect the newly added IoT device 130a-h or sensor 131a, 131b and the universal device 102 may request initialization information from the newly added IoT device 130a-h or sensor 131a, 131b. The initialization information may include the type of IoT device 130a-h or sensor 131a, 131b, what controllable functions the IoT device 130a-h or sensor 131a, 131b has, and what the parameters may be changed to enable the operation of a sensor or to control the functions of an IoT device.

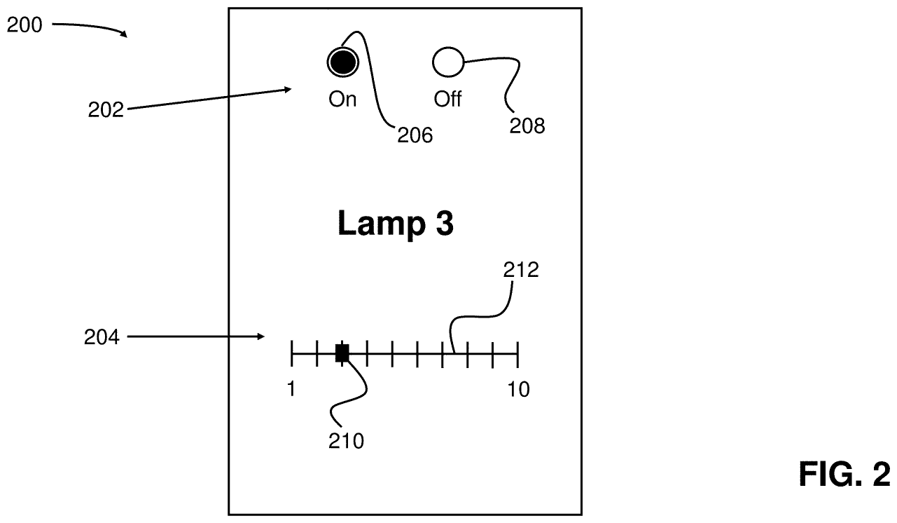

With reference to FIGS. 1 and 2, the initialization information may be used by a software application stored on the computing device 104 to create a user interface 200. The user interface 200 may have control surfaces 202, 204 for controlling the parameter values of the functions.

The universal device 102 may, in turn, send some or all of the initialization information to the computing device 104. The initialization information may include an identifier for the IoT device 130a-h or sensor 131a, 131b. The identifier may be a binary sequence. The initialization information may further include which features may be controlled through the user interface 200, and which type of control surface 202, 204 corresponds to each feature. The self-identification information may also include what control parameters correspond to the control surface 202, 204 for controlling a particular feature. Control parameters may include what category of control, that is, a brightness level, a time period, or other category. Control parameters may also include the range of possible parameter values, as is described in detail below.

With reference to FIGS. 1 and 2, the computing device 104 includes in the app a subroutine which receives data from the universal device 102 and creates a user interface 200. The app receives the initialization information from the universal device 102. The initialization information may provide how many IoT devices 130a-h and sensors 131a, 131b are on the IoT system, a unique identification for each, the available function or functions for the one or more IoT devices 130a-h and available parameters for the one or more IoT devices 130a-h and sensors 131a, 131b. Using the initialization information, the app on the computing device 104 may automatically create a user interface 200. There is no action required by the user to create the user interface 200 beyond connecting the computing device 104 to the universal device 102 and opening the app.

The user interface 200 may include one or more screens. The one or more screens may include screens which display data including a condensed amount of data from each of the sensors. Alternatively, or in addition, a single screen may include an average of the measurements taken by one type of sensor. The user interface may include one or more screens for controlling the one or more functions of the one or more IoT devices. The one or more screens may include control surfaces.

By way of example and not limitation, the control surfaces may map to a specific IoT devices 130a-h and sensors 131a, 131b. The IoT device 130a-h may have a first function which responds to a binary control parameter. This control parameter may be, for example, state of operation control parameter which includes the values “on” and “off.” As a part of the user interface 200, the software application may create a control surface 202 corresponding to the function and control parameter. In the case of a binary control parameter the user interface 200 may include a control surface 202 which includes two radio buttons 206, 208. A first radio button 206 may allow a user to send a command turn the system module on by selecting the first radio button 206, which is labelled “on,” and a second radio button 208 may allow a user to send a command turning the system module off by selecting the second radio button 208, which is labelled “off.”

The screen on the user interface may have an additional control surface. The control surface may map to the same IoT device. The IoT device may have a second function which has a control parameter which includes a range of values. For example, the range of values may be a wattage value, or may be an indexed number, for example 1 to 10, used to designate levels of resistance in a circuit, to control a volume level. As a part of the user interface 200, the software application may create a control surface corresponding to the function and control parameter. In the case of a control parameter with a range of values, the user interface 200 may include a control surface 204 which includes a scale of values. As shown in FIG. 2, the values range from 1 to 10. However, it is understood that the values may begin at any number, and may end at any number. The range of values may be more than 10, and the range of values may be less than 10. The user may slide the marker 210 along the scale 212 to each of the indexed positions in order to control the function.

The one or more sensors 131a, 131b connected to the IoT system 100 may each have a screen. On the screen may be information, including what type of data the sensor 131a, 131b measures. As will be described in detail below with regard to closed loop operation of portions of the IoT system 100, the sensor 131a, 131b may have certain parameters which may be set which will affect the operation of the sensor 131a, 131b, specifically, if the sensor 131a, 131b takes a measurement matching set parameter value, then the sensor 131a, 131b may send a control signal to one or more pre-determined IoT devices 130a-h to control the operation of the one or more pre-determined IoT devices 130a-h.

A user may send control signals from the user interface 200 to control one of the one or more IoT devices 130a-h. Alternatively, or in addition, the user may send control signals from the user interface 200 to control a plurality of the IoT devices 130a-h. In a similar way, the user may send control signals from the user interface 200 to set parameters for a plurality of the one or more sensors 131a, 131b.

The PLC protocol is designed so that control signals include an identifier as to which of the one or more IoT devices 130a-h and sensors 131a, 131b the message is directed. Although eight IoT devices 130a-h and two sensors 131a, 131b are shown, it will be understood that the IoT system 100 may have more than eight IoT devices and two sensors or less than eight IoT devices and two sensors. If a message is not directed to a particular IoT device 130a-h or sensor 131a, 131b, that IoT device 130a-h or sensor 131a, 131b ignores the message. The PLC protocol may further include an identifier that includes all of the IoT devices 130a-h and sensors 131a, 131b. Using the identifier which includes all of the IoT devices 130a-h and sensors 131a, 131b, a user may send a control signal which affects all of the IoT devices 130a-h and sensors 131a, 131b, for example, to turn off all of the IoT devices 130a-h and sensors 131a, 131b. The control surfaces which affect all of the IoT devices and sensors on the IoT system may be on a separate screen.

The computing device 104 may access the IoT system 100 through the universal device 102, which means that the universal device may receive all control signals sent by the computing device and transmits all data and acknowledgements sent by the IoT devices and sensors to the computing device, over either the wired or wireless connection. In addition to these communications functions, the universal device 102 performs several other functions. First, the universal device 102 converts the messages of the computing device 104 to the PLC protocol. The universal device 102 includes instructions which allow the universal device 102 to recognize which operating system the computing device 104 is using, and establish bilateral communication with the computing device 104. Then, when the computing device 104 sends messages, the universal device 102 converts the messages in to the PLC protocol used for communication between the universal device 102 and the IoT devices and sensors 106a-h. Second, the universal device 102 provides routing functions for messages sent by the computing device 104 to the various IoT devices and sensors 106a-h and between the IoT devices and sensors. Third, the universal device 102 provides device management. When a new IoT device or sensor 106a-h is added, the universal device 102 may detect the addition of the IoT device or sensor 106a-h and request initialization information from the IoT device or sensor 106a-h. The initialization information may include an identification code for the IoT device or sensor 106a-h, what functions the IoT device or sensor 106a-h has, and what the control parameters for the functions are. The universal device 102 may store this information in a non-transient media memory 122.

The one or more IoT devices 130a-h or one or more sensors 131a, 131b, or both, include circuits and components which perform functions. For example, every room in a structure may need one or more lighting fixtures. Each of these lighting fixtures may be IoT devices. The light functions may have one or more control surfaces 202, 204. For example, there may be a first control surface 202 for “on,” which turns the light on at maximum brightness, and a second control surface 204 which affects the wattage output of the light, commonly known as a dimmer. The second control surface 204 may be represented as a slide, or an indexed slide 212. Alternately, only the second control surface 204 may be used, and set to o watts or “off” when the control surface is at a minimum setting and at max brightness when the control surface is set to the opposite side. When a user manipulates the control surfaces on the computing device, the user interface generates messages which are sent to the universal device 102. As described above, the messages may then be converted to control signals by the PLC protocol. These control signals are broadcast on the power line 112 by the universal device 102. The sole function for most sensors may be taking a particular type of measurement and sending the result of the measurement as data to the universal device 102 and, ultimately, the computing device 104.

The display screen 103 as part of the universal device 102 or computing device 104 may be used as a system interface by a user (not shown). Certain control signals which may be executed by the PLC protocol may be indicated by visual representations, or control surfaces, on the touch screen. For example, the control signals may be indicated by icons or text, or a combination of both. When a user touches the portion of the screen with the visual representation, it causes a control signal to be sent in a message to the universal device 102, which interprets the control signal using the PLC protocol.

In forming the control signal, the universal device 102 includes identification information as to which of the one or more IoT devices 130a-h or which of the one or more sensors 131a, 131b the control signal is directed. As discussed above, the identification information ensures that the correct IoT device or sensor, or both receives the control signal, and other IoT devices and sensors are on notice that the control signal is not directed to those other IoT devices and sensors. If an IoT device 130a-h or sensor 131a, 131b determines that the control signal is directed to that IoT device 130a-h or sensor 131a, 131b, then the IoT device 130a-h or sensor 131a, 131b processes a command contained within the control signal. The command directs a change in the one or more functions of the IoT device or sets a parameter value for the sensor. As discussed above, the PLC protocol command may be converted to a proprietary command for execution by the one or more IoT devices or sensor. Customized hardware built on the foundational architecture of the IoT device 130a-h or sensor 131a, 131b may complete the execution of the command. Contemporaneously, the IoT device 130a-h or sensor 131a, 131b may each generate a control signal directed to the universal device 102, and ultimately, to the computing device 104. The control signal may include an acknowledgement that the control signal directed to the IoT device 130a-h or sensor 131a, 131b was received. If such an acknowledgement is not received, the computing device 104 or the universal device 102 may resend the original control signal at pre-determined time intervals until the computing device 104 receives the acknowledgement.

The computing device 104 may also send parameters which affect the operation of one or more sensors 131a, 131b on the IoT system 100, as is described in greater detail below. The operation of the IoT system 100, from the manipulation of the control surface to the sending of the acknowledgement is the same, with the exception that the control signal includes a command which sets a parameter for the one or more sensors 131a, 131b. The parameter may set a parameter for the one or more sensors 131a, 131b. For example, if the one or more sensors are brightness sensors, then the parameter value may be a brightness value.

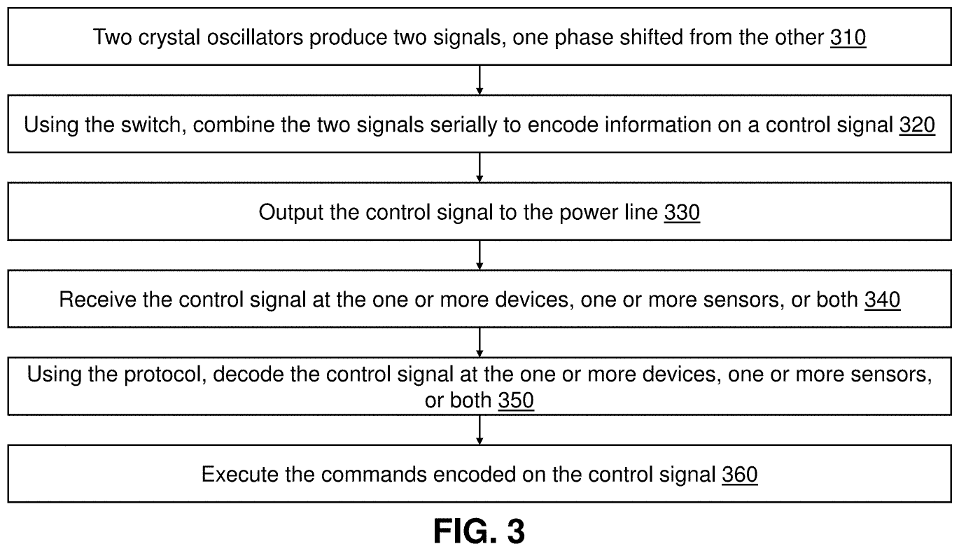

As shown in FIGS. 1, 4, and 5, in order to send commands to one or more IoT devices 130a-h or sensors 131a, 131b, commands from the user interface 200 on the computing device 104 or display screen 103 are converted to control signals by the universal device 102 using the PLC protocol. The control signal has two parts. The first part is two sinusoidal waves 410, 412, which two crystal oscillation circuits generate continuously, as shown in Step 310 on FIG. 3. The second part is binary control information which is encoded using the sinusoidal waves, which is shown in Step 320 of FIG. 3. After generation, the sinusoidal waves 410, 412 are fed to the connected switch 114, as is described above. The switch 114 is also connected to a processor 124 which executes the protocol by operating the switch 114. Based on the command signals from the computing device 104, which are converted by the processor in the universal device 102 using the PLC protocol, the processor 124 directs the switch 114 to switch between the two sinusoidal waves, one of which is phase shifted by the phase shift circuit 116 from the other. Information is encoded by switching the switch 114 from the non-phase shifted wave 410 to the phase shifted wave 412 and back to the non-phase-shifted wave 410. Each of the waves 410, 412 may represent a binary state. For example, one wave may represent a first binary state, for example, one, and the second wave may represent a second binary state, for example, zero. By adding each of the waves 410, 412 serially at certain intervals, control information which may be encoded by the PLC protocol. The resulting sinusoidal wave with the control information is called a control signal 500, and has some portions in a first phase state 502, and some portions in a second phase state 504.

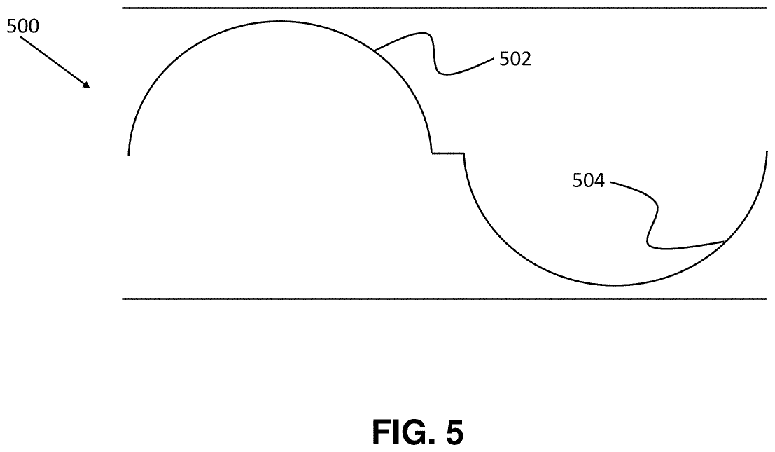

The timing for the switch 114 between waves 410, 412 with differing phase states may be set to a single cycle of the wave frequency. Alternatively, the timing may be set to a fractional portion of the cycle of the wave frequency. The timing may be specified within the PLC protocol. Thus, the number of cycles or fractions of a cycle one phase state or the other of the wave appears on the control signal, may be indicative of several consecutive instances of a binary state. In this way, the PLC protocol may interpret the control signal as a series of binary states, with the binary states representing either a one or a zero. Commands may be defined by the PLC protocol from differing binary sequences, or combinations of ones and zeros. As shown in FIG. 5, the timing of the control signal 500 is set to half a wave cycle, and the phase states 502, 504 change at the zero crossing.

Sequences of ones and zeros may form data or commands that can be sent as messages over the power lines 112. These messages may be received by a receiver portion 108 of the transceiver 126a-i and analyzed and converted by the PLC protocol. As an example, one IoT device may be a light fixture and the system may further include a separate temperature sensor. Each of the light fixture and the temperature sensor may identify themselves using a binary code of a set number of digits. The identification may be a shorter or longer sequence than those of the commands. The PLC protocol may define a preliminary indicator which indicates the start of a command or data string, and a second indicator which indicates the command or data send is complete and requests that the lighting fixture or fixtures, or temperature sensors to which the command was directed send an acknowledgement. Similarly, the PLC protocol may use binary sequences to define commands. By way of example and not limitation, the PLC protocol may define that “1001” may correspond to a command to turn a lighting fixture to 100% of the wattage, while “1000” may correspond to a command to turn the lighting fixture off. The data and commands may be packaged as messages that include the preliminary indicator that a command or data follows, headers which identify to which lighting fixtures the command is directed, the command, and an indicator that the command is complete and a request for acknowledgement of the command by the lighting fixture or temperature sensor.

When the control signal 500 is created by combining sinusoidal waves 410, 412 of differing phase states, the amplitude and frequency of the resulting control signal 500 are the same as that of the two sinusoidal waves 410, 412. Only the phase is sometimes changed in creating the control signal 500. Thus, the control signal 500 is output to the power line 112 with the frequency and amplitude unaffected from when the sinusoidal waves 410, 412 were generated by the crystal oscillators. Also, the amplitude is unaffected at this stage, as the only amplification, if any, takes place within the crystal oscillation circuits.

Once the control information is encoded on the control signal 500, the control signal 500 is output to the power line 112 as is shown in Step 330 of FIG. 3. The output is a broadcast throughout the power line 112. An exemplary control signal 500 is shown in FIG. 5. The control signal 500 includes alternating phase states 502, 504 at different intervals. The change in phase state may be seen at a zero crossing as the signal moves laterally one direction or another depending on which phase state the control signal is changing from, and which phase state the control signal is changing to.

Referring now to FIGS. 1, 3, 5, and 6, if PLC is being used, on the receiving end, the control signal 500 is received on an input/output port 622 and passed to the transceiver 624 of the one or more IoT devices 130a-h or one or more sensors 131a, as is shown in Step 340 of FIG. 3. The crystal filter of the transceiver 624 bandpasses only a bandwidth of 50 Hz or less centered on the transmission frequency of the crystal oscillator from the signal on the power line 112, allowing the remainder of the signal to remain on the line. Naturally, the rest of the signal on the power line 112 may be band passed so that the power on the power line 112 may be used to power the one or more IoT devices 130a-h and sensors 131a, 131b which may be connected. The 50 Hz or less bandwidth captures the control signal 500 because the phase shifting does nothing to spread the bandwidth of the original sinusoidal waves generated by the crystal oscillators, which are on a single frequency. That is to say, the control signal is not the result of encoding information by frequency modulation. Again, the frequency remains constant.

Following the filtering, the PLC protocol stored on a memory 628, and executing on a processor 626, on the one or more IoT devices 130a-h or one or more sensors 131a, 131b, detects and analyzes the information in the control signal 500. The control information encoded on the control signal 500 may be decoded and converted by the PLC protocol as is shown in Step 350 of FIG. 3. The conversion may result in instructions which are executable to give commands to the one or more IoT devices and to set control parameters for the functions of the IoT devices 130a-h, or to set parameters for the one or more sensors 131a, 131b as is shown in Step 360 of FIG. 3, and described above.

The use of ultra-narrow bandwidth and phase shifting combined with PLC protocol defined timing of the phase states 502, 504 in the control signal 500 provides robust protection against interference by electrical noise on the power line 112. In order for electrical noise on the IoT system 100 to interfere with the control signal, the electrical noise would need both reach in to the narrow bandwidth on which the oscillator is transmitting, and the filter is receiving, and to shift its phase to match the control signal 500. This kind of rapid phase shifting is uncommon in electrical noise, including the noise typically found on power lines 112. Thus, in addition to all the other ways the IoT system 100 is robust against electrical noise, in order to provide a clear control signal 500, even the manner in which the information is encoded within the control signal 500 provides robustness against interference by electrical noise. This largely mitigates concerns about electronic noise interfering with the control signal 500, and makes a separate wiring infrastructure even less attractive, given the cost of a separate wiring infrastructure.

The one or more IoT devices 130a-h and one or more sensors 131a, 131b may then execute the command sent. Contemporaneously, the one or more IoT devices 130a-h and sensors 131a, 131b may send a confirmation to the universal device 102 that the command has been received. Once the command has been executed, the one or more IoT devices 130a-h may further send an update to the universal device 102 showing the current operating state, including the new parameter setting. The updated operating state may be reflected in the user interface 200. The universal device 102 may communicate with the computing device 104 to confirm the new state of operation for the one or more IoT devices 130a-h and sensors 131a, 131b.

Unlike previous IoT devices and ecosystems, the disclosed IoT system 100 allows for not only control signals 500 created or timed by a user accessing the IoT system 100 from a computing device 104 operating through the universal device 102, but the disclosed IoT system 100 may include sensors 131a, 131b sending control signals to IoT devices 130a-h in point to point communication on the IoT system 100. Thus, the disclosed IoT devices 130a-h and independent sensors 131a include a combination of hardware and software which allows for point to point communication without the need for messages to pass through the universal device 102 or any other device acting as a “hub” of the IoT system 100. Thus, in addition to the open loop operation in which the computing device 104 might originate commands, the IoT system 100 may operate in closed loop environment where the sensors send control signals to operate the one or more IoT devices 130a-h. Because these modes of operation may occur at least contemporaneously, and potentially simultaneously, the disclosed system includes a hybrid open loop/closed loop operation.

Further, each of the one or more IoT devices 130e may include a sensor 131b, or a sensor 131a may be associated with, but physically separate from, the one or more of the IoT devices 130a-d, 130f-h. The sensor may use the parameter values set by the computing device 104 as trigger points in controlling the IoT devices 130a-h in a closed loop operation. In the closed loop operation, the sensor 131a, 131b and IoT device 130a-h communicate directly. The sensor 131a, 131b provides the control signal 500, rather than the computing device 104, acting through the universal device 102. For example, the sensor 131a, 131b may be a brightness sensor. The sensor may be integrated with a light fixture, or may be physically separate, but may include software which identifies one or more light fixtures to which the sensor may send control signals, based on measurements taken by the sensor matching input parameters.

To accomplish both the messaging necessary for the open loop and the closed loop communication, the transceivers 106, 126a-i on both the universal device 102 and on the IoT devices and sensors 130a-h, 131a may be nearly identical or identical. The transceivers 106, 126a-i may contain both a transmission circuit and a receiver circuit described in additional detail above. The transceivers 106, 126a-i are included in both the universal device 102 and each of the IoT devices 130a-h and any independent, that is, not integrated, sensors 131a because communication routed through a single device is both risky and impractical, particularly when the communication may be point to point and bi-directional as the operation of the system allows.

The following examples are used to illustrate how the closed loop operation of the one or more IoT devices and one or more sensors works. The examples are not meant to be limiting, but rather only illustrative of how some aspects of this technology works. By way of example and not limitation, a sprinkler system for outdoor watering is traditionally a standalone system which may not be controlled by a mobile device, or as part of an integrated IoT system. However, using one or more IoT devices and one or more sensors to replace the traditional controller of the sprinkler system, the sprinkler system is readily integrated in to the disclosed IoT system 100. The IoT device itself may only allow for turning the sprinklers on or off. However, sensors may be added with one or more parameters each. For example, one sensor may be added which is a clock. Parameter values may be set which cause the sprinkler system to turn on or off at pre-determined times. A second sensor may be integrated or assigned to control the sprinkler system. This second sensor may be a rain sensor. When the rain sensor detects rain within less than a predetermined period before the first sensor is set to turn the sprinkler system on, the rain sensor may send a control signal to the IoT device to ignore the next control signal from the first sensor. Thus, if there is rain shortly before the sprinkler system is set to run, the second sensor sends a control signal formed using the PLC protocol and transmitted to the power lines by the transceiver for the sprinkler system IoT device to ignore the next control signal from the first sensor. The pump included in a swimming pool filtration system may also be added to the IoT system 100 in a similar way. The addition of atypical devices to the IoT system 100 is another way in which the IoT system 100 creates universality.

In some instances, the IoT devices 130e and sensors 131b may be a single device, and the sensor may generate control signals which are executed internally. By way of example and not limitation, a thermostat IoT device may include one or more sensors inherently. For example, thermostats typically include a temperature sensor. The thermostat may include additional sensors, such as a humidity sensor. The temperature sensor may send commands to a blower and condenser, which are only connected to the IoT system through the thermostat. Thus, the control signals generated by the thermostat, based on the temperature sensor measurement travel along separate wiring from the electrical power wiring in the structure. This means that the commands are executed internally.

The PLC protocol of the system disclosed herein presents new possibilities for heating, ventilation, and air conditioning (HVAC) systems. With traditional HVAC systems, extra low voltage wiring has to be run in the structure to carry the control signals from the thermostat to the blower and condenser. With the IoT system 100, the same control signals may be generated and then sent using the PLC protocol. The low voltage wiring required to send signals between the thermostat and other HVAC components may be eliminated, and control signals which cause the same effects may be sent from the thermostat on to the power line. With this configuration, the thermostat may be a programmable sensor, and the blower and condenser IoT devices. Traditional blowers and condensers will need a foundational architecture adapter. Some manufacturers may choose to include the foundational architecture in their blowers and condensers, and these would be able to join the IoT system without the use of an adapter. The thermostat would not be collocated with the blower or condenser, but would provide the primary control of those IoT devices in a closed loop operation.

The IoT system 100 may also use wireless connections in combination with the PLC connection. For example, a wireless connection may be made between the computing device 104 and the universal device 102, and, in some instances, between a sensor and the universal device 102. For example, the computing device 104 may connect to the universal device 102 through a wireless connection, as discussed above. Further, the universal device 102 may make use of a wireless connection to the cloud for certain functions. For example, the universal device 102 may access the cloud to store configuration settings for the IoT system 100. Alternatively, or in addition, the IoT system 100 may access computer code for creating user interfaces 200 based on the self-identification information the IoT devices 130a-h and the sensors 131a, 131b provide. Also, if a user is not physically collocated with the IoT system 100, the user may access the IoT system 100, and specifically the universal device 102, via the internet using the computing device 104. Thus, the universal device 102 may have both a wired connection, for example, via power line 112, and a wireless connection via, for example, WiFi, to connected to a computing device 104 via the internet or local area network as is well known in the art.

Because the universal device 102 and the IoT devices 130a-h and sensors 131a, 131b communicate in most instances via the PLC protocol, and because the bandwidth available via PLC is large in comparison to the data needs of the PLC protocol, the communication between the universal device 102 and the IoT devices 130a-h and sensors 131a, 131b is fast. In fact, the universal device 102 can communicate with each of the attached IoT devices 130a-h and sensors 131a, 131b multiple times in a fraction of a second. Such a communication configuration allows for near instantaneous changes when required by a user.

As an alternative, the universal device 102 and the one or more IoT devices 130a-h and sensors 131a, 131b may communicate via a wireless connection. The universal device 102 and the one or more IoT devices 130a-h and sensors 131a, 131b may use WiFi protocol, or Bluetooth®, or other wireless protocols which allow the exchange messages between the IoT devices 130a-h, sensors 131a, 131b, and the universal device 102.

Below are some nonlimiting example embodiments described above.

In a 1st Example, an internet of things system to provide for communication between devices, comprising: an electrical power line; one or more IoT devices electrically connected to the power line, the one or more IoT devices each including a first set of circuitry for performing a first set of one or more functions, a first transceiver, a first memory, and a first processor, a PLC protocol stored on the first memory and executing on the first processor to send messages over the electrical power line, including initialization information, or control signals or sensor data, or a combination of initialization information, control signals, and sensor data; and a universal device electrically connected to the electrical power line and wirelessly connected to at least one computing device, so that the universal device exchanges messages with the one or more IoT devices and the at least one computing device, the universal device including a power line transceiver and a wireless transceiver; wherein the one or more IoT devices, at least one computing device and universal device all use a common foundational hardware design and the communication protocol to communicate directly from one of the one or more IoT devices to another of the one or more IoT devices, or from one of the one or more IoT devices through the universal device to one of the at least one computing device.

In a 2nd Example, the system of Example 1, wherein the initialization information includes one or more functions for the one or more IoT devices.

In a 3rd Example, the system of any of Examples 1-2, wherein the software application further includes instructions for creating a user interface based on the initialization information.

In a 4th Example, the system of Example 3, wherein the user interface includes one or more control surfaces which generate commands for operating a corresponding one of the one or more IoT devices.

In a 5th Example, the system of Example 4, wherein a user operates the control surfaces on a touch screen display of the computing device.

In a 6th Example, the system of any of Examples 1-5, further including one or more sensors electrically connected to the electrical power line, the one or more sensors each including a second transceiver to send control signals on the electric power line, a second processor electrically connected to the second transceiver, and a second memory electrically connected to the second processor, the second memory including a copy of the PLC protocol.

In a 7th Example, the system of Example 6, wherein the one or more sensors are assigned to one or more IoT devices and the one or more sensors send control signals to the one or more IoT devices to operate the one or more IoT devices.

In a 8th Example, a method for providing control of an IoT system, comprising: providing a computing device including a display; connecting a universal device to the computing device via a wired or wireless connection; connecting one or more IoT devices to the universal device via a wired connection, the one or more IoT devices and the universal device each including a transceiver to send and receive messages formatted using a PLC protocol; sending a message from the computing device to the one or more IoT devices requesting initialization information; sending a message from the one or more IoT devices to the computing device including the initialization information, the initialization information including information regarding one or more unique functions of the corresponding one of the one or more IoT devices and control parameters of the one or more unique functions; creating a user interface for displaying on the display of the computing device, the user interface including control surfaces which, when manipulated by a user, cause a change in a value of one of the control parameters of one of the one or more functions of one of the one or more IoT devices; and manipulating a control surface to operate one of the one or more IoT devices.

In a 9th Example, the method of Example 8, wherein the connection between the universal device and the one or more system modules is a wired connection.

In a 10th Example, the method of Example 9, wherein the wired connection is made through electrical power lines.

In a 11th Example, the method of any of Examples 8-10, wherein the PLC protocol is stored on one or more memories, each one of the one or more memories being electrically connected to the transceiver in each of the one or more IoT devices and the universal device.

In a 12th Example, the method of any of Examples 8-11, wherein the one or more IoT devices each include one or more unique functions, circuitry for performing the one or more unique functions, a processor electrically connected to the transceiver, and a memory electrically connected to the processor, the PLC protocol stored on the memory and executing on the processor.

In a 13th Example, an IoT system for allowing the interoperation of devices, comprising: a computing device for sending control signals using a PLC protocol; a universal device including a first transceiver for sending data to, and receiving data from, the computing device, and a non-transitory first memory electrically connected to the transceiver, the first memory containing the PLC protocol; one or more IoT devices connected to the universal device through electrical power lines, the one or more IoT devices each including one or more unique functions, the one or more IoT devices each including a second memory storing a first copy of the PLC protocol, and a second transceiver electrically connected to the second memory and communicating with the universal device using the PLC protocol; and one or more sensors connected to the one or more IoT devices through the electrical power lines, the one or more sensors each including a third memory storing a second copy of the PLC protocol, and a third transceiver electrically connected to the third memory and communicating with the universal device using the PLC protocol; wherein one of the one or more sensors sends a control signal directly to one or more of the one or more IoT devices.

In a 14th Example, the system of Example 13, wherein the universal device, the one or more IoT devices, and the one or more sensors all include foundational architecture.

In a 15th Example, the system of any of Examples 13-14, wherein at least one of the one or more IoT devices has an integrated sensor.

In a 16th Example, the system of Example 15, wherein the integrated sensor communicates direct to the one of the one or more IoT devices without the signal being placed on the electrical power lines.

In a 17th Example, the system of any of Examples 13-16, wherein the PLC protocol encodes information using two phase shifted sinusoidal waves.

In a 18th Example, the system of Example 17, wherein the sinusoidal waves are each generated by a crystal oscillator.

In a 19th Example, the system of any of Examples 13-18, wherein the one or more control surfaces generate commands for changing control parameters on a corresponding one of the one or more IoT devices.

In a 20th Example, the system of any of Examples 13-19, including two or more IoT devices, the two or more IoT devices having only the foundational architecture in common.

The above description is given by way of example, and not limitation. Given the above disclosure, one skilled in the art could devise variations that are within the scope and spirit of the invention disclosed herein, including various ways of connecting the IoT devices, sensors, and universal device for communication. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An internet of things system to provide for communication between devices, comprising:
an electrical power line;
one or more IoT devices electrically connected to the power line, the one or more IoT devices each including a first set of circuitry for performing a first set of one or more functions, a first transceiver, a first memory, and a first processor, a PLC protocol stored on the first memory and executing on the first processor to send messages over the electrical power line, including initialization information, or control signals or sensor data, or a combination of initialization information, control signals, and sensor data; and
a universal device electrically connected to the electrical power line and wirelessly connected to at least one computing device, so that the universal device exchanges messages with the one or more IoT devices and the at least one computing device, the universal device including a power line transceiver and a wireless transceiver;
wherein the one or more IoT devices, at least one computing device and universal device all use a common foundational hardware design and the communication protocol to communicate directly from one of the one or more IoT devices to another of the one or more IoT devices, or from one of the one or more IoT devices through the universal device to one of the at least one computing device.

2. The system of claim 1, wherein the initialization information includes one or more functions for the one or more IoT devices.

3. The system of claim 1, wherein the software application further includes instructions for creating a user interface based on the initialization information.

4. The system of claim 3, wherein the user interface includes one or more control surfaces which generate commands for operating a corresponding one of the one or more IoT devices.

5. The system of claim 4, wherein a user operates the control surfaces on a touch screen display of the computing device.

6. The system of claim 1, further including one or more sensors electrically connected to the electrical power line, the one or more sensors each including a second transceiver to send control signals on the electric power line, a second processor electrically connected to the second transceiver, and a second memory electrically connected to the second processor, the second memory including a copy of the PLC protocol.

7. The system of claim 6, wherein the one or more sensors are assigned to one or more IoT devices and the one or more sensors send control signals to the one or more IoT devices to operate the one or more IoT devices.

8. A method for providing control of an IoT system, comprising:
providing a computing device including a display;
connecting a universal device to the computing device via a wired or wireless connection;
connecting one or more IoT devices to the universal device via a wired connection, the one or more IoT devices and the universal device each including a transceiver to send and receive messages formatted using a PLC protocol;
sending a message from the computing device to the one or more IoT devices requesting initialization information;
sending a message from the one or more IoT devices to the computing device including the initialization information, the initialization information including information regarding one or more unique functions of the corresponding one of the one or more IoT devices and control parameters of the one or more unique functions;
creating a user interface for displaying on the display of the computing device, the user interface including control surfaces which, when manipulated by a user, cause a change in a value of one of the control parameters of one of the one or more functions of one of the one or more IoT devices; and
manipulating a control surface to operate one of the one or more IoT devices.

9. The method of claim 8, wherein the connection between the universal device and the one or more system modules is a wired connection.

10. The method of claim 9, wherein the wired connection is made through electrical power lines.

11. The method of claim 8, wherein the PLC protocol is stored on one or more memories, each one of the one or more memories being electrically connected to the transceiver in each of the one or more IoT devices and the universal device.

12. The method of claim 8, wherein the one or more IoT devices each include one or more unique functions, circuitry for performing the one or more unique functions, a processor electrically connected to the transceiver, and a memory electrically connected to the processor, the PLC protocol stored on the memory and executing on the processor.

13. An IoT system for allowing the interoperation of devices, comprising:
a computing device for sending control signals using a PLC protocol;
a universal device including a first transceiver for sending data to, and receiving data from, the computing device, and a non-transitory first memory electrically connected to the transceiver, the first memory containing the PLC protocol;
one or more IoT devices connected to the universal device through electrical power lines, the one or more IoT devices each including one or more unique functions, the one or more IoT devices each including a second memory storing a first copy of the PLC protocol, and a second transceiver electrically connected to the second memory and communicating with the universal device using the PLC protocol; and
one or more sensors connected to the one or more IoT devices through the electrical power lines, the one or more sensors each including a third memory storing a second copy of the PLC protocol, and a third transceiver electrically connected to the third memory and communicating with the universal device using the PLC protocol;
wherein one of the one or more sensors sends a control signal directly to one or more of the one or more IoT devices.

14. The system of claim 13, wherein the universal device, the one or more IoT devices, and the one or more sensors all include foundational architecture.

15. The system of claim 13, wherein at least one of the one or more IoT devices has an integrated sensor.

16. The system of claim 15, wherein the integrated sensor communicates direct to the one of the one or more IoT devices without the signal being placed on the electrical power lines.

17. The system of claim 13, wherein the PLC protocol encodes information using two phase shifted sinusoidal waves.

18. The system of claim 17, wherein the sinusoidal waves are each generated by a crystal oscillator.

19. The system of claim 13, wherein the one or more control surfaces generate commands for changing control parameters on a corresponding one of the one or more IoT devices.

20. The system of claim 13, including two or more IoT devices, the two or more IoT devices having only the foundational architecture in common.
